(19) United States
(12) Patent Application Publication
(10) Pub. No.: US 2015/0135957 A1
(43) Pub. Date: May 21, 2015

(54) Organosiloxane Films for Gas Separations

(71) Applicant: Applied Membrane Technology, Inc., Minnetonka, MN (US)

(72) Inventor: Ashok K. Sharma, Hopkins, MN (US)

(73) Assignee: Applied Membrane Technology, inc., Minnetonka, MN (US)

(21) Appl. No.: 14/083,843

(22) Filed: Nov. 19, 2013

(51) Int. Cl. B01D 53/22; B01D 67/00

(52) U.S. Cl. CPC B01D 53/228; B01D 67/0037
USPC 96/10; 96/4; 96/11; 427/569

(57) ABSTRACT

A semipermeable gas separation membrane is plasma deposited from liquid organosiloxane monomer having at least three silicon atoms and an alpha hydrogen atom. The semipermeable membrane may be employed as a gas-selective membrane in combination with a porous substrate.

### FIELD OF THE INVENTION

The present invention relates to plasma polymerized films generally and more particularly to gas separation membranes employing a plasma polymerized film derived from a liquid organosiloxane monomer.

### BACKGROUND OF THE INVENTION

Gas separation membranes employing a thin polymeric film have been extensively studied for a wide array of applications. For many gas separation membranes, a thin film is applied to a flat porous substrate, wherein the film contributes the permselective properties to the combination.

The thin film effectuating the gas separation may also be applied in the form of a coating on a porous substrate, such as microporous hollow fibers in a bundle, which is commonly referred to as a hollow fiber module. The microporous hollow fiber substrate may be organic, inorganic, or oragno-metallic.

Various polymers have been used as the thin film for gas separations, though researchers are yet to discover a thin film forming polymer that achieves both good gas selectivity and good permeability in order to meet pressing industrial demands. Moreover, conventional polymers offer limited options in the development of suitable polymer-based gas separation films due to the complexity of synthesis, lack of film formation characteristics, poor solubility or chemical resistance.

Among conventional polymers, polyorganosilocones, in general, have been targeted for certain applications due to their biocompatibility, low coefficient of friction, and ease of production. Depositing an ultra-thin film of conventional polyorganosilicones, however, remains a challenge. As a consequence, membranes synthesized from conventional polyorganosilicones exhibit low gas permeability (due to their relatively high thickness), poor gas selectivity, poor mechanical properties and poor adhesion.

Plasma polymerization of organic compounds has been used, as an alternative technique, to obtain thin film coatings that are free from pollutants or unwanted byproducts. Most plasma-derived polymers are inert, and exhibit strong adhesion to the underlying substrate. The ability to deposit a film with extremely low thickness also lends advantages in the construction of gas separation membranes of high gas permeability.

Plasma polymerized polymer coatings therefore overcome some of the drawbacks of conventional coating techniques, as they can be deposited as an ultrathin film and provide good gas permeability but most plasma polymers suffer from a low rate of polymer deposition, insufficient pore coverage and hence inferior gas separation characteristics. Most plasma polymers also suffer from poor shelf life in the form of degraded permeability characteristics as they continue to interact with the atmospheric oxygen. Organosilicone-based coatings with high gas selectivity and high gas flux have remained elusive, and have therefore not been widely used in applications in industry where high flux-selective gas permeation is sought.

Among the organosilicone compounds, plasma polymerized organosiloxanes have received particular attention of plasma researchers due to their structural similarity to conventional silicon rubber. Commercially useful coatings have been prepared from plasma polymerization of tetramethyldisiloxane (TMDSO) and hexamthyldisiloxane (HMDSO) monomers for applications in the biomedical areas, for example, for providing lubricity to the substrate. Both TMDSO and HMDSO are relatively low molecular weight compounds that can be easily volatized in the plasma chamber, which is why they have been widely used for plasma polymerization. These monomers, however, suffer from a low rate of polymer deposition, and thus poor substrate pore coverage, and therefore find limited use in gas separation applications.

The use of high molecular weight Organosiloxanes, with boiling points in excess of 100 degree C., has generally been avoided due to the fear of low vapor pressure and hence even lower rate of polymer deposition. In some applications, fluorinated organic compounds have been co-polymerized with the organosiloxanes to improve hydrophobicity, abrasion resistance and polymer deposition rate. Such fluorinated copolymers, however, suffer from poor bondability to common substrates and adhesives, particularly in membrane applications. As a result, leakage is a commonly-cited problem in membrane modules fabricated from fluorinated copolymers of organosiloxanes.

### SUMMARY OF THE INVENTION

Conventional thought on feed monomers in plasma-induced polymerizations has focused upon gas-phase and volatile monomers of relatively low molecular weight to facilitate rapid volatilization, fragmentation and polymerization in the plasma reaction chamber. Applicant has, however, discovered that, contrary to common thinking, certain higher molecular weight feed monomers, such as higher molecular weight Organosiloxanes, in spite of their low volatility, may actually exhibit a higher rate of plasma polymerization than the more commonly employed more volatile, lower molecular weight organosiloxanes, such as Hexamthyldisiloxane (HMDSO) and Tetramethyl disiloxane (TMDSO). Organosiloxane monomers with at least three silicon atoms and at least one hydrogen atom bonded directly to a respective silicon atom (hereinafter referred as an alpha-hydrogen) surprisingly polymerized more rapidly, and formed a stronger, more integral film than the lower molecular weight organosiloxane monomers. The polymerization properties of these higher molecular weight organosiloxane monomers resulted in films with gas separation characteristics suitable for commercial applications. It was further surprisingly found that the films formed from these relatively higher molecular weight monomers also exhibited an increased gas flux and reduced aging effects in comparison to films formed from commonly used lower molecular weight organosiloxane monomers.

Among the relatively higher molecular weight organosiloxane monomers useful in the preparation of gas separation membranes of the present invention, applicant has noted the importance of an alpha-hydrogen atom bonded directly to a respective silicon atom. Because the silicon-hydrogen bond has a lower bond energy (94 Kcal/mole) than the carbon-hydrogen bond (112 Kcal/mole), organosiloxanes containing an alpha-hydrogen polymerize readily through a silicon radical propagation reaction, more than through a methylene radical route. The predominantly silicon radical route of the proposed plasma polymerization results in a less cross-linked and mostly linear polymer structure in comparison to a polymer derived through the methylene radical route. Applicant theorizes that the reduced cross-link density of the polymer structure based upon an alpha-hydrogen containing organosiloxane monomer contributes to the surprisingly high gas permeability exhibited in the present films. The weaker silicon-hydrogen bond may also drive the increased rate of polymerization with respect to organosiloxane monomers without an alpha-hydrogen atom.

It was also found that the oxygen:silicon (O:Si) ratio in the organosiloxane monomer contributed to the reactivity of the monomer in plasma polymerization. The discovered benefit of increased O:Si ratio is surprising in light of the ablative properties of oxygen in plasma-driven reactions. It is theorized that the increased presence of oxygen aids in polymerization of the monomer by providing “Oxy” radicals in the same manner as that provided by the conventional oxygen-enriched peroxide catalysts in the polymerization of conventional monomers.

The semi-permeable membranes for gas separations of this invention thus includes a polymer that is plasma deposited from an organosiloxane monomer having at least three silicon atoms and an alpha-hydrogen atom bonded directly to a respective silicon atom. The membrane exhibits a carbon dioxide gas flux of at least about 0.5*10⁻³ cm³/cm²*s*cm (Hg), and a carbon dioxide/oxygen (Co₂/O₂) selectivity of at least about 1.5. The organosiloxane monomer may have a ratio of oxygen atoms to silicon atoms of at least 0.66:1 and may be vaporizable in a plasma environment at a temperature of less than 180° C. and a pressure of between 1-400 mtorr, and plasma polymerizable at ambient temperature (considered to be less than 30° C.) at a pressure of 1-400 mtorr.

A gas separation module includes a porous substrate and a coating on the substrate, with the coating being plasma deposited from an organosiloxane having at least three silicon atoms and an alpha-hydrogen atom bonded directly to a respective silicon atom. The coating exhibits permeability to a first gas that is greater than its permeability to a second gas.

A method for coating a substrate to form a gas separation module includes vaporizing a feed organosiloxane monomer having at least three silicon atoms and an alpha-hydrogen atom bonded directly to a respective silicon atom. The organosiloxane monomer is plasma polymerized for deposition onto the substrate as a coating, such that the coated substrate has a carbon dioxide gas flux of at least about 0.5*10⁻³ cm³/cm²*sec*cm (Hg), and a carbon dioxide/oxygen (Co₂/O₂) selectivity of at least about 1.5.

It is to be understood that some organosiloxane monomers of the present invention may include a plurality of alpha-hydrogen atoms, wherein more than one silicon atom each has a respective hydrogen atom directly bonded thereto.

### DETAILED DESCRIPTION OF THE INVENTION

The present invention is directed to thin films plasma polymerized/deposited from organosiloxane monomers, wherein the thin films exhibit gas flux and gas selectivity suitable in gas separation applications. The plasma polymerized films may be deposited on a substrate for use as a gas separation module. The thin film may be applied to a porous substrate as a functional and structural support of the membrane module. The deposited polymeric film may therefore be considered as a gas-permeable surface modifier to the underlying substrate, so as to provide gas selectivity without undue diminishment of gas flux.

An example device to which the present invention is applicable includes a blood oxygenator in which oxygen-rich gas flows through tubular gas permeable membranes. As blood flows around the gas permeable membranes, oxygen passes into the blood, thereby causing blood oxygenation, and carbon dioxide passes from the blood into the tubular membranes. Besides the gas exchange properties, the thin polymer coatings of this invention may also prevent blood from wetting the pores of the micro porous substrate making the membrane device usable over a longer period of time.

For the purposes hereof, the terms “membrane” and “membrane module” refer to a device through which a fluid stream is passed for purposes of filtration, and, in the present invention, one which permits the passage of certain fluids to the exclusion of, or at faster rates than other fluids. The terms “membranes” and “membrane modules” may be used interchangeably herein, and may refer to a self-supporting mono or multi-layer film, or composites of mono or multi-layer films with a substrate. The membranes and membrane modules of the present invention are typically considered gas-permeable and liquid-impermeable, and possess permselective properties i.e. one gas transmits at a higher rate than the other. The gas separation by these semipermeable membranes is thought to occur by a solution diffusion mechanism, where the gases first get dissolved in the membrane surface and subsequently diffuse to the other side due to the concentration gradient. Mathematically the solution diffusion of gases through membrane is expressed by the formula:

P=S×D

Where, P is the permeability coefficient, S is the solubility coefficient and D is the diffusion coefficient. Gas with the higher Permeability coefficient transmits at a higher rate through the membrane.

As noted above, substrates useful in the practice of this invention vary widely. In typical embodiments, the substrate is gas permeable, and may be porous (e.g., microporous, ultraporous or nanoporous) The substrates may be in various forms, including films, fibers, webs, powders, and other shaped articles, and may be formed of organic materials, inorganic materials, or a combination of such materials. Organic substrates include polymeric materials such as thermoset and thermoplastic polymers, such as those described in U.S. Pat. No. 7,258,899, herein incorporated by reference. A particular organic substrate for use in the present invention is microporous polypropylene fibers.

In addition to the organic and inorganic substrates generally described above, microporous, ultraporous, and/or nanoporous glass and ceramics in fiber forms, tubular forms, or as monoliths and the like are also suitable.

The organosiloxane monomers from which the semi permeable film of the present invention is plasma polymerized includes, in each molecule, at least three silicon atoms and at least one alpha-hydrogen atom, with each alpha-hydrogen atom bonded directly to a respective silicon atom. Accordingly, some organosiloxanes of the present invention are in accordance with general Formula I:

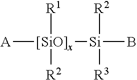

Wherein:
R¹, R², R³ and R⁴ are each independently selected from group consisting of C₁₋₄ alkyl, alkenyl, Hetro functionality or Hydrogen;
A is hydrogen or C₁₋₄ alkyl;
B is hydrogen or a C₁₋₄ alkyl;
X is an integer ≧2; and
At least one of A and B is hydrogen
   Example organosiloxanes useful in the invention in accordance with general Formula I include:
1,1,1,5,5,5-Hexamethyltrisiloxane
1,1,1,3,5,5,5-Heptamethyltrisiloxane
Tris(trimethylsiloxy) silane
1,3-Bis(Trimethylsiloxy)1,3-dimethyldisiloxane
Bis(Trimethylsiloxy)ethylsilane
1,3-Diphenyl 1,1,3,3-tetrakis(dimethylsiloxy)disiloxane
1,1,3,3,5,5,7,7 octamethyltetrasiloxane;
1,1,1,3,3,5,5 heptamethyltrisiloxane;
1,1,3,3,5,5-hexamethyltrisiloxane;
Nonamethyltetrasiloxane; and
Dodecamethylpentasiloxane

Cyclosiloxanes in accordance with general Formula II shown below may also be used as the organosiloxane monomer.

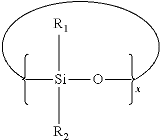

Wherein Wand R² are each independently selected from group consisting of C₁₋₄ alkyl, alkenyl, Hetro functionality or Hydrogen, and at least one of the group in the chain is hydrogen.
Example cyclosiloxanes include:
1,3,5,7-tetramethylcyclotetrasiloxane;
1,3,3,5,5,7,7-heptamethylcyclotetrasiloxane;
1,3,5,7,9-pentamethylcyclopentasiloxane; and
1,3,5,7-tetraethylcyclotetrasiloxane
2,4,6 trimethylcyclotrisiloxane

The above-listed organosiloxanes are not exhaustive as to the organosiloxane monomers contemplated as being useful in the present invention. Thus any organosiloxane monomer having at least three silicon atoms in its molecular structure and an alpha-hydrogen atom bonded to a respective silicon atom, and which can be plasma polymerized in a vacuum environment at a pressure between 1-400 mtorr, is a potential monomer candidate for the formation of gas separation membranes of the present invention.

### EXAMPLES

The following general example is provided to present the techniques employed in forming the gas separation films set forth in the specific examples.
1. Substrate Preparation: Porous substrates such as Polypropylene hollow fiber and films do not require any cleaning prior to polymer deposition and are used as received.
2. Preparation of Organosiloxane Monomer: Organosiloxanes used in this study were employed in a form as received, without blending with any solvent.
3. Volatilization of Organosiloxane: Many Organosiloxane have adequate vapor pressure at room temperature. Some may require heating in order to generate the monomer feed rate required for the study. Heating is generally performed under vacuum so that the monomer does not oxidatively disintegrate. Inert gas can be used as carrier to facilitate volatilization or to assist in plasma polymerization.
4. Plasma Reactor: A tubular plasma reactor, employing capacitively coupled external electrodes, powered by a RF power generator at 13.56 MHz through a matching network of conductors and capacitors was used for this study. The porous substrate (hollow fiber membrane or flat film) was passed through the plasma zone, reel to reel, using a network of motors, pulleys and mechanical couplings. The pressure in the plasma chamber was set by controlling monomer feed rate, reactor dimensions, and outlet pressure, and was monitored by a Baratron gauge. The monomer flow rate was controlled by MKS/Unit Mass flow controllers operating in different ranges, varying from 0-20 to 0-500 SCCM of Nitrogen.
5. Plasma treatment and conversion: Hollow fiber substrates are plasma polymer coated in a semi-continuous manner wherein the uncoated substrate is moved from reel to reel through the plasma zone. Once the substrate is loaded, the system is evacuated and the requisite amount of monomer/s vapors are allowed to enter the plasma chamber through one of the monomer mass flow controllers. An Inert gas such as Argon or Helium can be incorporated to improve monomer flow kinetics. Reactive gases, such as Nitrogen, Oxygen, Freon, Ammonia, and the like can also be incorporated to improve deposition efficiency and/or nitrogen/oxygen/fluorine content of the polymer or to add new functionality, or to fine tailor other properties of the deposited film. System pressure in each case is adjusted to the desired level by throttling the vacuum pump valve or by changing monomer feed rate. Once the pressure is stabilized the glow is turned on and at the same time the hollow fiber substrate is allowed to pass through the plasma zone where it becomes coated by the plasma polymer before it rewinds on the take up spools in the product zone. The thickness of the coating is controlled by adjusting the speed of the substrate fiber movement through plasma zone and/or by varying the discharge power, and/or the monomer feed rate. Blends of two or more similar or widely different monomers may be used to produce copolymers which may have distinctly different properties and applications than the homopolymer produced from a single monomer. Both pulsed and continuous plasmas may be used.
   Flat Microporous substrates may be coated in the same manner using a batch or semi-continuous reactor. Rigid substrates may be coated in a batch process.
6. Optional processing steps: The partially coated fiber may be recoated with another polymer or treated with reactive plasma using the same or different process to improve its performance or to provide additional functionalities. In certain cases the coated fiber is further reacted with a biomolecule, such as heparin to impart hemo-compatible properties to the membrane. In yet another case, the coated fiber may be further modified using conventional chemistry in order to impart specific fluid separation characteristics.
7. Testing Gas permeability of the coated Fiber. The membranes prepared by the general method described above are often tested for their gas separation properties. A known length of fiber membrane is wrapped around a plastic shepherd hook and potted at one end with epoxy resin in such a way that the inner lumen of the hollow fiber membrane is separated from the outer surfaces of the fibers in the bundle. CO₂, O₂ and N₂ gases are generally used for the permeability measurement. Other gases can be employed depending on the end application of the membrane. In each case the amount of gas flow rate through the lumens of the fiber membrane at a specific gas pressure and for a specific surface area of the membrane is measured using an array of mass flow meters. An average of minimum three membrane samples is reported. Gas selectivity is calculated from the specific gas flux measured through the membrane for different gases.

### Specific Examples

The following specific examples are provided to demonstrate the principles of the present invention, and follow the procedure set forth in the above general example.

### Example 1

For comparison purposes microporous Polypropylene Hollow Fiber membrane, trade name Celgard X30/240, was coated with a thin coating of plasma polymer formed from 1,1,3,3-Tetarmethyldisiloxane (TMDSO) monomer vapors in a plasma environment at 70 watts RF power, 60 mtorr pressure, 110 SCCM monomer flow rate (measured on MKS mass flow controller calibrated for Nitrogen). The exposure time was 12.5 seconds.

### Example 2

For comparison purposes microporous Polypropylene Hollow Fiber membrane, trade name Celgard X30/240, was coated with a thin coating of plasma polymer formed from a 1,1,3,3-Tetarmethyldisiloxane (TMDSO) monomer vapors in a plasma environment at 70 watts RF power, 40 mtorr pressure, 110 SCCM monomer flow rate (measured on MKS mass flow controller calibrated for Nitrogen). The exposure time was 12.5 seconds.

### Example 3

For comparison purposes microporous Polypropylene Hollow Fiber membrane, trade name Celgard X30/240, was coated with a thin coating of plasma polymer formed from 1,1,3,3-Tetarmethyldisiloxane (TMDSO) monomer vapors in a plasma environment at 60 watts RF power, 30 mtorr pressure, 55 SCCM monomer flow rate (measured on MKS mass flow controller calibrated for Nitrogen). The exposure time was 12.5 seconds.

### Example 4

For comparison purposes microporous Polypropylene Hollow Fiber membrane, trade name Celgard X30/240, was coated with a thin coating of plasma polymer formed from a 1,1,1,3,3,3-Hexamethyldisiloxane (HMDSO) monomer vapors in a plasma environment 70 watts RF power, 40 mtorr pressure, 110 SCCM monomer flow rate (measured on MKS mass flow controller calibrated for Nitrogen). The exposure time was 12.5 seconds

### Example 5

For comparison purposes microporous Polypropylene Hollow Fiber membrane, trade name Celgard X30/240, was coated with a thin coating of plasma polymer formed from 1,1,1,3,3-Pentamethyldisiloxane (PMDSO) monomer vapors in a plasma environment at 70 watts RF power, 40 mtorr pressure, 110 SCCM monomer flow rate (measured on MKS mass flow controller calibrated for Nitrogen). The exposure time was 12.5 seconds.

### Example 6

For comparison purposes microporous Polypropylene Hollow Fiber membrane, trade name Celgard X30/240, was coated with a thin coating of plasma polymer formed from 1,1,3,3,5,5,7,7-Octamethylcyclotetrasiloxane (OMCTS) monomer vapors in a plasma environment at 15 watts RF power, 14 mtorr pressure, 30 SCCM monomer flow rate (measured on MKS mass flow controller calibrated for Nitrogen). The exposure time was 34 seconds.

### Example 7

Microporous Polypropylene Hollow Fiber membrane, trade name Celgard X30/240, was coated with a thin coating of plasma polymer formed from 1,1,3,3,5,5-Hexamethyltrisiloxane (HMTSO) monomer vapors in a plasma environment at 70 watts RF power, 60 mtorr pressure, 110 SCCM monomer flow rate (measured on MKS mass flow controller calibrated for Nitrogen). The exposure time was 12.5 seconds.

### Example 8

Microporous Polypropylene Hollow Fiber membrane, trade name Celgard X30/240, was coated with a thin coating of plasma polymer formed from 1,1,3,3,5,5-Hexamethyltrisiloxane (HMTSO) monomer vapors in a plasma environment at 70 watts RF power, 40 mtorr pressure, 110 SCCM monomer flow rate (measured on MKS mass flow controller calibrated for Nitrogen). The exposure time was 12.5 seconds.

### Example 9

Microporous Polypropylene Hollow Fiber membrane, trade name Celgard X30/240, was coated with a thin coating of plasma polymer formed from 1,1,3,3,5,5-Hexamethyltrisiloxane (HMTSO) monomer vapors in a plasma environment at 70 watts RF power, 30 mtorr pressure, 110 SCCM monomer flow rate (measured on MKS mass flow controller calibrated for Nitrogen). The exposure time was 12.5 seconds.

### Example 10

Microporous Polypropylene Hollow Fiber membrane, trade name Celgard X30/240, was coated with a thin coating of plasma polymer formed from 1,1,3,3,5,5-Hexamethyltrisiloxane (HMTSO) monomer vapors in a plasma environment at 60 watts RF power, 30 mtorr pressure, 55 SCCM monomer flow rate (measured on MKS mass flow controller calibrated for Nitrogen). The exposure time was 12.5 seconds.

### Example 11

Microporous Polypropylene Hollow Fiber membrane, trade name Celgard X30/240, was coated with a thin coating of plasma polymer formed from 1,1,3,3,5,5,7,7-Octamethyltetrasiloxane (OMTSO) monomer vapors in a plasma environment at 60 watts RF power, 30 mtorr pressure, 55 SCCM monomer flow rate (measured on MKS mass flow controller calibrated for Nitrogen). The exposure time was 12.5 seconds.

### Example 12

Microporous Polypropylene Hollow Fiber membrane, trade name Celgard X30/240, was coated with a thin coating of plasma polymer formed from 1,3,5,7-Tetramethylcyclotetrasiloxane (TMCTS) monomer vapors in a plasma environment at 15 watts RF power, 14 mtorr pressure, 30 SCCM monomer flow rate (measured on MKS mass flow controller calibrated for Nitrogen). The exposure time was 34 seconds

Examples 1-6 represent comparison data to the films of the present invention represented in Examples 7-12.

### Results

Gas permeability (specific Flux of N₂, O₂, CO₂), gas selectivity (αCO2/O2 and αO2/N2) and Membrane Utilization Factor (MUF) were tested on the example films. The MUF is an empirical parameter derived by dividing the square of the selectivity of the membrane for carbon dioxide to oxygen (αCO2/O2), by the gas permeability of the membrane to CO2, (CO2 Flux) multiplied by 1,000. Values for the MUF greater than unity are desired for gas separation applications. The gas flux and selectivity data were obtained by measuring the permeability of the membrane to CO2, N2 and 02 gases as described herein.

The following Table 1 demonstrates the surprisingly enhanced gas flux and selectivity of the membranes prepared by plasma polymerization of relatively higher molecular weight organosiloxane monomers (HMTSO and OMTSO vs. TMDSO). The CO₂ flux is presented in the unit of 10⁻³ cm³/cm²·sec·cm (Hg).

TABLE 1

| Example | CO₂ Flux | CO₂/O₂ | O₂/N₂ | MUF (CO₂) |
|---|---|---|---|---|
| Example 1 | 1.17 | 3.86 | 1.96 | 17.43 |
| Example 7 | 1.74 | 4.06 | 1.90 | 28.68 |
| Example 2 | 1.78 | 3.11 | 1.45 | 17.21 |
| Example 8 | 2.50 | 3.60 | 1.63 | 32.40 |
| Example 9 | 2.62 | 3.81 | 1.75 | 38.03 |
| Example 3 | NO SEPN | n/a | n/a | 0.00 |
| Example 10 | 0.69 | 1.55 | 1.09 | 1.66 |
| Example 11 | 0.68 | 2.12 | 1.24 | 3.06 |

The gas flux, selectivity, and MUF data in the following Table 2 demonstrates the discovered benefit of one or more alpha-hydrogen atoms per monomer molecule:

TABLE 2

| Example | CO₂ Flux | CO₂/O₂ | O₂/N₂ | MUF (CO₂) |
|---|---|---|---|---|
| Example 2 | 1.78 | 3.11 | 1.45 | 17.21 |
| Example 5 | 5.97 | NO SEPN | n/a | 0.00 |
| Example 4 | 14.00 | NO SEPN | n/a | 0.00 |
| Example 12 | 1.02 | 4.53 | 2.00 | 20.96 |
| Example 6 | 2.62 | 1.96 | 1.14 | 10.06 |

The results demonstrate the importance of an alpha-hydrogen atom bonded to a respective silicon atom in the plasma polymerization of the organosiloxanes. The membrane in Example 5 was deposited from HMDSO, a monomer with molecular weight intermediate between that of TMDSO and HMTSO, under identical conditions as those employed in polymerizing from TMDSO and HMTSO, but was found to have a very low polymerization rate, and nearly no film forming tendency as depicted by high carbon dioxide flux and very low to no gas selectivity. Applicant theorizes that such lack of film forming tendency may be due to the lack of alpha-hydrogen atoms in the HMDSO monomer. The Membrane Utilization Factor (MUF) for the membrane in Example 5 was 0, as contrasted from an MUF of 17.21 for the Example 2 preparation.

The cyclic organosiloxane monomers in Examples 7 and 13 were found to follow the same trend. Here again, the Example 13 preparation using the TMCTS monomer, that has alpha-hydrogen atoms, exhibited much higher MUF than the Example 7 preparation formed from OMCTS monomer, which has no alpha-hydrogen atoms in spite of the higher molecular weight of the OMCTS monomer.

Perhaps the most surprising aspect of the present invention is the slow aging tendency of the membranes prepared from relatively higher molecular weight organosiloxane monomers with alpha hydrogen(s). It is well known that plasma polymers continue to crosslink and react with atmospheric gases (oxygen, water vapors etc) until full saturation. This ongoing oxidation results in the reduction of gas flux and selectivity performance of the membrane. It was surprisingly discovered that, under identical storage conditions, membranes deposited from plasma polymerization of relatively higher molecular weight HMTSO monomer exhibited not only less reduction in carbon dioxide flux at 28 and 60 days, but also showed an increase in carbon dioxide/nitrogen selectivity compared to the membranes prepared from TMDSO monomer. The following table demonstrates results taken from membranes prepared from TMDSO and HMTSO monomers under identical plasma polymerization and storage conditions:

TABLE 3

| | Aging | Change In CO₂ | Change In CO₂/N₂ |
|---|---|---|---|
| Monomer | Period | Flux | Selectivity |
| TMDSO | 28 Days | −15.2% | −3.4% |
| HMTSO | 28 Days | −9.80% | +1.7% |
| TMDSO | 60 Days | −18.5% | −5.0% |
| HMTSO | 60 Days | −12.9% | +1.5% |

What is claimed is:

1. A semi permeable membrane for gas separations, said membrane comprising a polymer that is plasma polymerized from an organosiloxane monomer having at least three silicon atoms and a hydrogen atom bonded directly to a respective silicon atom, said membrane having a carbon dioxide gas flux of at least about 0.5*10⁻³ cm³/cm²*sec*cm (Hg), and a carbon dioxide/oxygen selectivity of at least about 1.5.

2. A semi permeable membrane as in claim 1 wherein said organosiloxane monomer has a ratio of oxygen atoms to silicon atoms of at least 0.66:1.

3. A semi permeable membrane as in claim 1 wherein said organosiloxane monomer is vaporizable in an environment having a temperature of less than 180° C. and a pressure between 1-400 mtorr, and plasma polymerizable at an ambient temperature at a pressure of 1-400 mtorr.

4. A semi permeable membrane as in claim 1, including a second hydrogen atom bonded to another respective silicon atom.

5. A gas separation module, comprising:
a porous substrate; and
a coating on said substrate, said coating being plasma deposited from an organosiloxane having at least three silicon atoms and a hydrogen atom bonded directly to a respective silicon atom, said coating having a permeability to a first gas that is greater than its permeability to a second gas.

6. A gas separation module as in claim 5 wherein said substrate is a hollow fiber.

7. A gas separation module as in claim 5 wherein said organosiloxane has a ratio of oxygen atoms to silicon atoms of at least 0.66:1.

8. A gas separation module as in claim 5 wherein the first gas is carbon dioxide and the second gas is oxygen.

9. A method for coating a substrate to form a gas separation module, said method comprising:
vaporizing a feed organosiloxane monomer having at least three silicon atoms and at least two alpha-hydrogen atoms bonded to respective silicon atoms; and
plasma polymerizing said organosiloxane monomer for deposition onto the substrate as a coating, such that the coated substrate has a carbon dioxide gas flux of at least about 0.5*10⁻³ cm³/cm²*sec*cm (Hg), and a carbon dioxide/oxygen selectivity of at least about 1.5.

10. A method as in claim 9, including warming said feed organosiloxane monomer in a liquid bath to an extent sufficient to vaporize said feed organosiloxane monomer in a plasma polymerization reaction chamber at a pressure of between 1-400 mtorr.
